(19) United States
(12) Patent Application Publication
(10) Pub. No.: US 2014/0218834 A1
(43) Pub. Date: Aug. 7, 2014

(54) SURGE ARRESTER WITH A CAGE DESIGN

(71) Applicants: Hartmut Klaube, Hermsdorf (DE); Christoph Koch, Hermsdorf (DE)

(72) Inventors: Hartmut Klaube, Hermsdorf (DE); Christoph Koch, Hermsdorf (DE)

(21) Appl. No.: 13/980,709

(22) PCT Filed: Jan. 20, 2012
(86) PCT No.: PCT/EP2012/050916

§ 371 Date: Apr. 16, 2014

(30) Foreign Application Priority Data
Jan. 21, 2011 (DE) 10 2011 009 124.6

(51) Int. Cl. H02H 9/04

(52) U.S. Cl. CPC H02H 9/042
USPC 361/118

(57) ABSTRACT

The invention relates to a surge arrester comprising at least two mutually opposite fittings 3, at least one varistor block 5, which is arranged between the fittings 3, and at least one reinforcing element 7 in the form of a closed loop, which holds the fittings 3 and the varistor block 5 against one another under pressure. According to the invention, the reinforcing element 7 is held on each of the two fittings 3 in each case on at least two sides of the fitting 3. In this way, four sections 7a, 7b, 7c and 7d of the reinforcing element 7 are formed which extend from one fitting 3 to the other fitting 3 and ensure the mechanical stability of the surge arrester.

The invention relates to a surge arrester with a cage design.

In power supply systems, surge arresters are connected between the electrical line and ground in order to divert a surge in this line if necessary and thus to protect other component parts or devices in the electric power system.

Such surge arresters usually contain a stack of cylindrical varistor blocks, preferably consisting of a suitably doped sine oxide or similar ceramic material, which varistor blocks are held between two fittings. This arrangement is surrounded by a housing consisting of weathering-resistant plastics or porcelain.

The holding force which is required in order for the varistor blocks to make good Contact with one another and in order to ensure the desired mechanical strength is achieved in that the two end fittings are braced against one another via reinforcing elements consisting of an insulating plastics material. The reinforcing elements for their part are fastened on the fittings.

Such a surge arrester is known, for example, from EP 0614198 A. In the case of the surge arrester disclosed in this document, two separate reinforcing elements, which are each in the form of an individual insulating loop, are fitted in such a way that each insulating loop connects the two fittings, wherein the two insulating loops are fitted opposite one another on different sides of the respective fitting. In this way, four parallel strings of insulating material are formed which surround the varistor blocks in the form of a cage.

One problem with such a surge arrester consists in that at least two independent insulating loops are required. As a result, a relatively large number of individual component parts is required, which complicates the assembly of the surge arrester.

A further problem consists in that the surge arrester with this design can he subject to uneven loading if there are discrepancies in the insulating loop lengths or in the formations of the resting points on the fittings. This can result in uneven loading of the surge arrester and, in particular in combination with thermal expansion effects during operation of the surge arrester, edges of the varistor blocks can be overloaded on one side, with the result that bevelling can occur.

A further surge arrester with a similar loop design is known from EP 0810613 A. In the case of this surge arrester, the problem of uneven loading of the edges of the varistor blocks is solved in that a single insulating loop is used which runs centrally over the fittings.

One disadvantage with this surge arrester consists in the fact that assembly is complex and difficult since the insulating loop needs to be applied while the surge arrester is held together under pressure. With this design, it is not possible to tension the surge arrester only once the bracing elements have been fitted by means of a centrally running tensioning screw, as otherwise generally takes place. The way in which the insulating loop runs over the centre of the fittings does not leave any space for a tensioning screw. A tensioning screw provided outside the centre of the fittings would result in uneven loading of the varistors with the risk of bevelling.

Finally, EP 0230103 A discloses a further surge arrester, in which the two fittings are connected by means of an open strip or tape of insulating material which is stretched to and fro in meandering fashion a number of times between the two fittings so that it covers the entire circumference of the fittings.

A problem with this consists in that, when the strip is fitted, care needs to be taken to ensure that there is no single-sided loading which could damage the edges of a varistor block. Furthermore, it is difficult and complex to fasten the open strip at the end of the “winding operation” in a suitable manner such that strong adhesion is ensured even for a long time.

In respect of the problems associated with the cited prior art, an object of the invention consists in providing an improved surge arrester which enables simple and inexpensive installation and nevertheless allows safe operation over a long period of time.

This object is achieved by a surge arrester according to Claim 1. The dependent claims relate to further advantageous configurations of the invention.

The invention will be described in detail below on the basis of preferred embodiments with reference to the attached figures, in which:

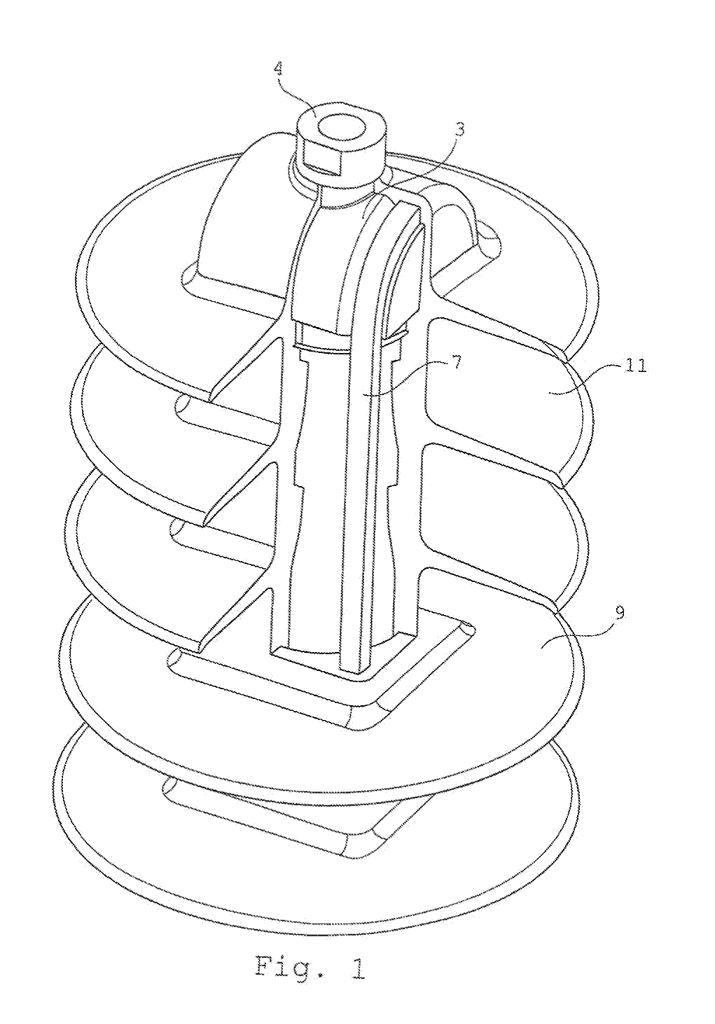

FIG. 1 shows a view of a surge arrester according to the invention with a housing in partial section;

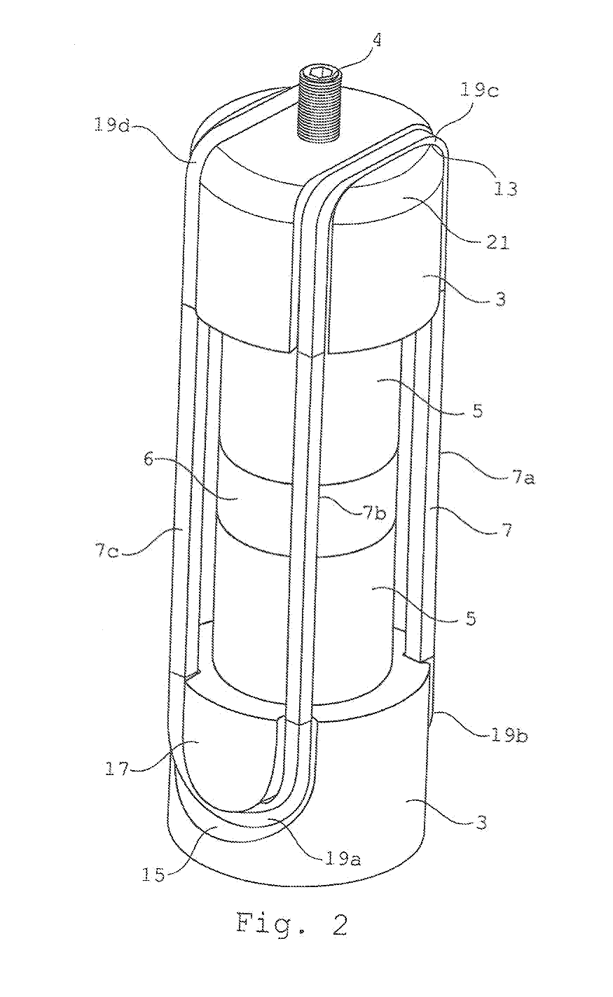

FIG. 2 shows a view of a surge arrester of a first embodiment according to the invention without the housing;

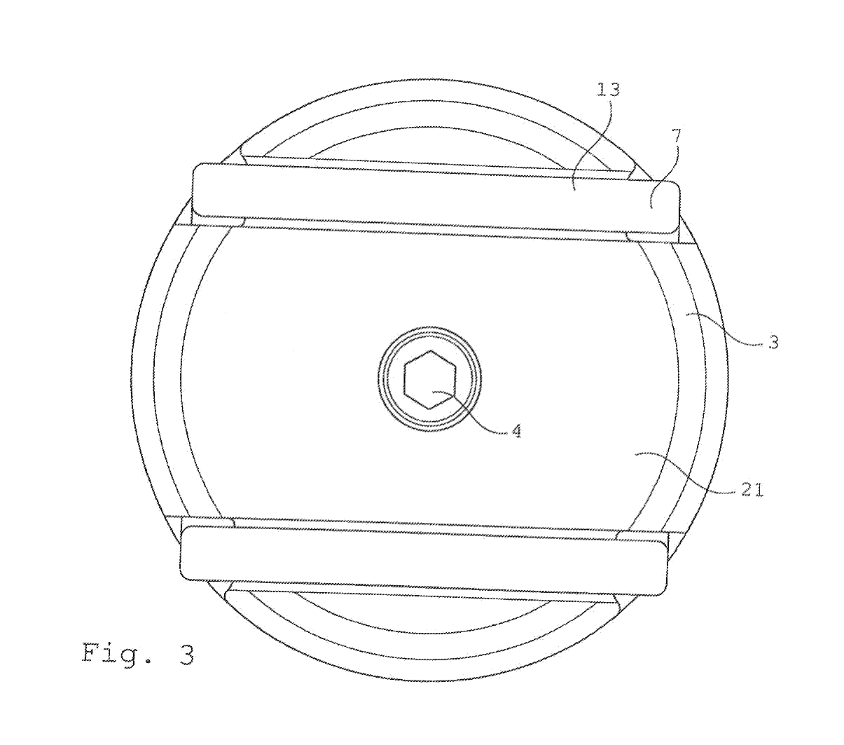

FIG. 3 shows a plan view of a fitting of the surge arrester shown in FIG. 2;

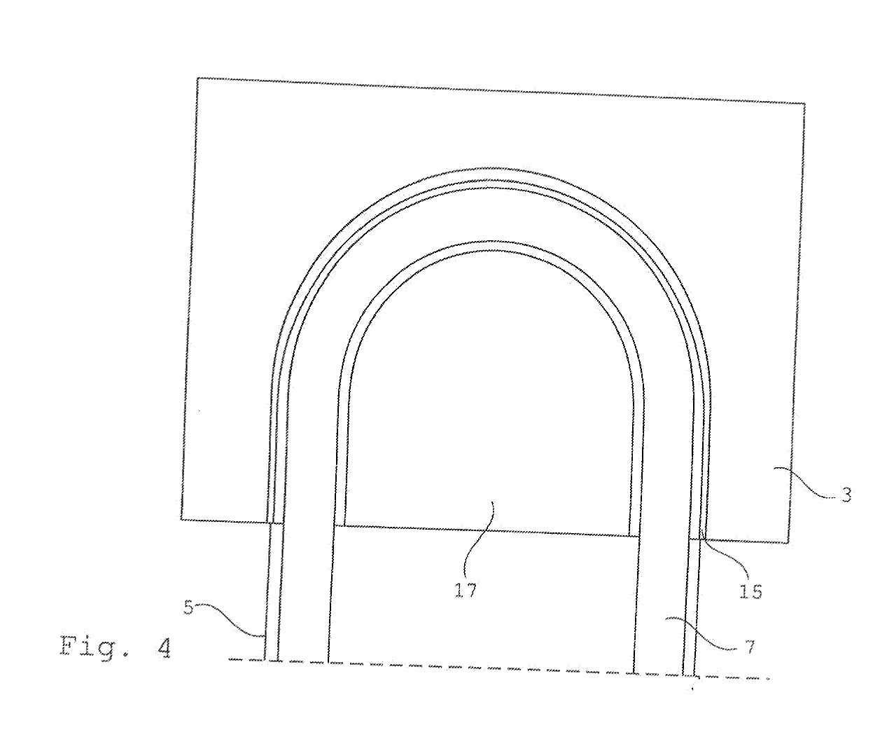

FIG. 4 shows a side view of another fitting of the surge arrester shown in FIG. 2;

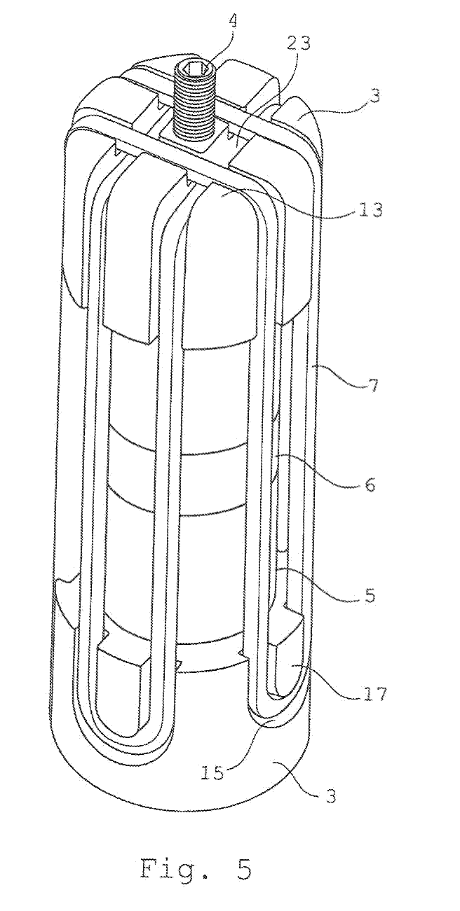

FIG. 5 shows a view of a second embodiment according to the invention of a surge arrester;

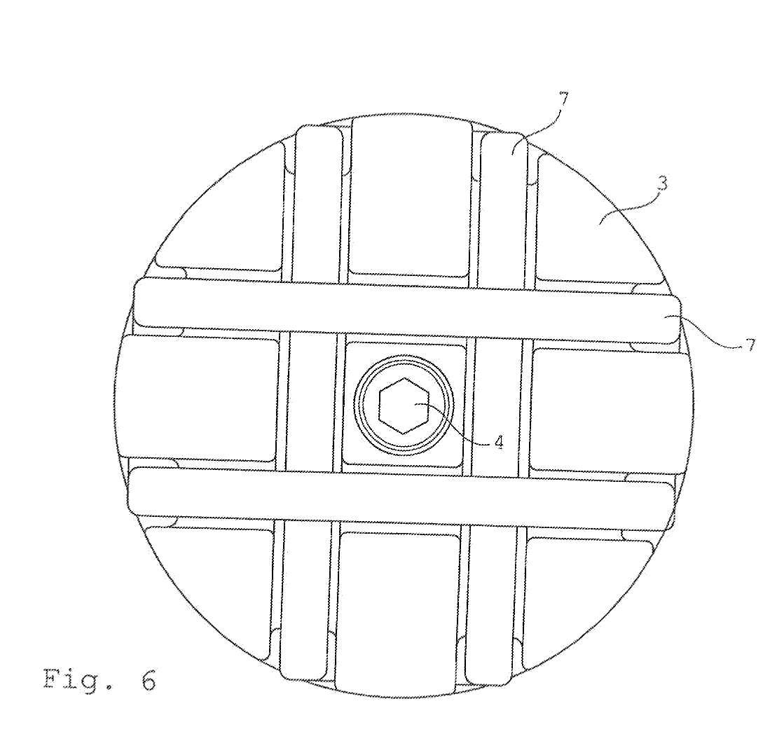

FIG. 6 shows a plan view of a fitting in the second embodiment; and

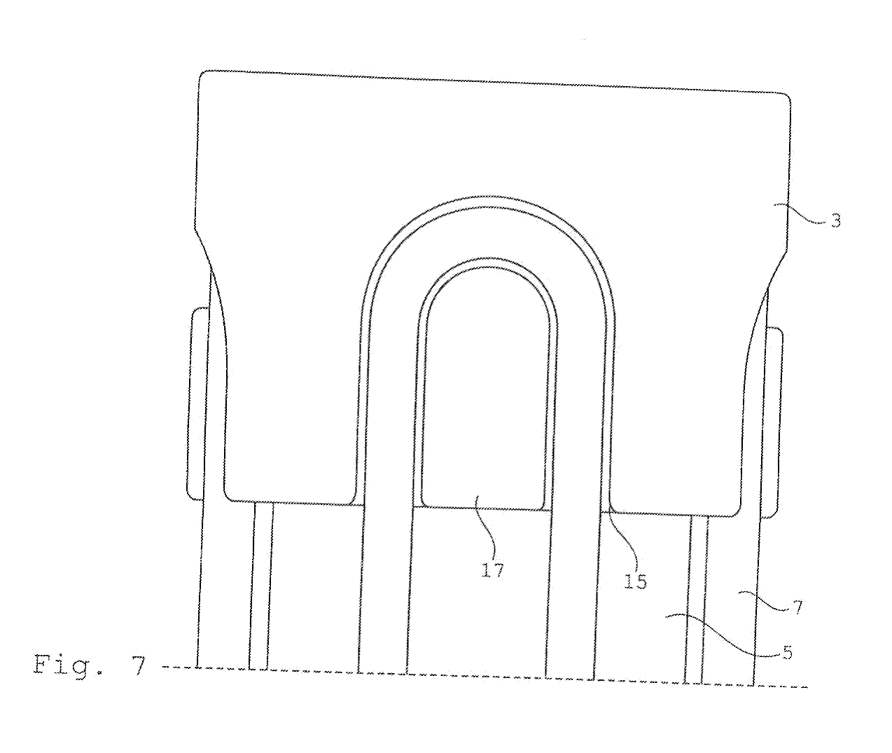

FIG. 7 shows a side view of another fitting of the surge arrester shown in FIG. 5.

The surge arrester with a cage design shown in FIG. 1 contains at least two fittings 3 and a housing 9 with shields 11. The housing 9 serves to protect against the environment and is preferably formed from silicone. The housing 9 can be produced by injection moulding or casting. The shields 11 have the function of extending or interrupting a leakage path for the current on the outer side of the surge arrester even on adhesion of contaminants or water. Depending on the planned use area, for example deserts, foggy regions, tropics, etc., the shields can be formed differently. In the case of use indoors, the shields can be dispensed with entirely.

The fittings 3 consist of metal, preferably aluminum or stainless steel, and are equipped with means for enabling an electrical connection to an electrical power system. In addition, they are equipped so as to enable mechanical fastening of the surge arrester.

One or more varistor blocks 5 are arranged as a stack between the fittings 3 within the housing 9, as can be seen in FIG. 2, which shows a view of a first embodiment according to the invention of a surge arrester without the h using and the shields.

Known ceramic discs with a voltage-dependent resistor (variable resistor) can be used as varistor blocks 5. At low voltages, they function as virtually perfect insulators, while they have good conductivity at high voltages. Conventional varistor blocks are produced on the basis of zinc oxide, ZnO. However, the invention is not restricted to zinc oxide, and s also possible for other metal oxides, plastics and also silicon carbide to be used for the varistor blocks by way of example. Furthermore, yet other blocks can be contained in the stack in addition to the varistor blocks 5, for example metal blocks 6 or spark gap blocks, in order thus to match the length of the surge arrester, its heat transfer and mode of operation to the requirements of the respective instance. As is conventional, spring elements, for example disc springs, can furthermore also be provided in the stack of varistor blocks 5, and these ensure a certain degree of elasticity and serve to maintain the electrical contact. In the conventional manner, the end faces of the varistor blocks 5 can also be equipped with corresponding electrodes, for example by virtue of being coated with aluminum.

In the preferred embodiment, the varistor blocks 5 are in the form of circular cylinders with a diameter of 5 cm, for example, and a height of 4 cm. Aluminum electrodes not shown in detail are attached to both sides of the varistor blocks 5 in order to ensure improved contact-making in order to further improve the contact-making, thin aluminum discs can be provided between the varistor blocks 5.

A stack formed by stacking such varistor blocks 5 and possibly metal blocks 6 one on top of the other is held between two fittings 3 in the surge arrester shown in FIG. 1. The fittings 3 are configured by means of a central screw 4 which protrudes out of the surge arrester and makes good contact between the electrical varistor blocks 5 in such a way that said fittings can easily be incorporated in existing electrical installations or power supply systems.

Preferably, the fittings 3 are blocks consisting of is aluminum with a diameter which is slightly larger than that of the varistor blocks 5. That face of at least one fitting 3 which faces the varistor blocks 5 can be configured by suitable shaping in such a way that mechanical loading of the edges of the contiguous varistor block 5 is avoided, for example by virtue of a peripheral groove being formed.

Surge arresters, when used outdoors, are subjected to considerable bending torques owing to the transmission of forces by electrical lines connected thereto. It is therefore necessary to ensure that the contact-making between the varistor blocks 5 and between the varistor blocks 5 and the fittings 3 is maintained even in the case of relatively large mechanical loading and bevelling of the varistor blocks as a result of two adjacent varistor blocks 5 canting is avoided. In order to achieve this, reinforcement elements 7, preferably glass-fibre-reinforced plastic bars or cables, are stretched between the fittings. These hold the varistor blocks 5 together between the fittings 3 with tension. Furthermore, occasionally the mentioned spring elements are introduced in the stack of varistor blocks 5 in order thus to ensure the contact-making even in the case of temperature fluctuations or the like.

As can further be seen from FIG. 2, the stack of varistor blocks 5 with a metal block 6 therebetween is illustrated between the two fittings 3. The stack is held together by a reinforcing element 7 in the form of closed loop, which is guided in such a way that the reinforcing element 7 is held on each of the two fittings 3 in each case on at least two sides, and at least four sections 7a, 7b, 7c, 7d, of which only the sections 7a, 7b, 7c are shown in FIG. 2, extend from one fitting 3 to the other. In other words, the reinforcing element 7 is in the form of a closed loop such that four loop ends 19a, 19b, 19c, are formed, of which in each case two are held on a fitting 3.

As is further shown in FIG. 2, respective shoulders 13 are formed in one of the fittings 3, with the result that the reinforcing element 7 wraps around the entire fitting 3, or a guide 15 in the form of a groove can be formed around a projection 17 in a side face of a fitting 3.

A central screw 4 in the form of a tensioning screw is formed in the centre of at least one of the two fittings 3, said screw being accommodated in a through-hole, and making it possible to brace the surge arrester during installation. Other tensioning apparatuses are likewise conceivable.

In the preferred embodiment, the reinforcing element 7 is formed from a rigid and dimensionally stable plastics material and is preformed in such a way that the four loop ends 19a 19b, 19C, 19d are already permanently predetermined with the desired interspaces and bends, as is required for the cohesion of the surge arrester. Such a reinforcing element 7 can be produced by virtue of a bundle of glass fibres being placed into a mould and then being cast with a suitable plastics material.

Preferably, the reinforcing element 7 is manufactured by glass-fibre injection-moulding methods. In this case, plastics compound provided with glass fibres is injected into a mould.

During installation, first the fitting 3 shown in FIG. 2 with the tensioning screw 4 can be inserted, and the two loop ends 19, 19a and 19b opposite this fitting can be bent up with respect to one another such that it is easily possible for the varistor blocks 5, the metal blocks 6 and finally the second fitting 3 to be inserted. After insertion of the fitting 3, it is possible for the reinforcing element 7 to return to its initial shape, with the result that it is then guided around the projection 17 in the groove 15 in the fitting 3. Then, the entire stack is braced. Preferably, for this purpose, first one of the two fittings 3 is lifted by means of a hydraulic lifting apparatus, while the other fitting 3 is held fast. In this lifted, state, the tensioning screw 4 is tightened and then the hydraulic lifting force is released. In this case, any spring elements which are present in the stack are tensioned. Likewise, aluminum contact discs between the varistor blocks 5, which can be provided in a preferred embodiment, are preformed under pressure. This operation of lifting a fitting 3, tensioning the tensioning screw and releasing the lifting force can be performed repeatedly.

In order to manufacture the surge arrester, said surge arrester is encapsulated by injection moulding with a silicone material in a further step after corresponding pretreatment, such as cleaning, preimpregnating or the like, with the result that the housing 9 with the shields 11 can be formed.

Such a surge arrester is easy and quick to produce and requires only a minimum number of component parts, so that installation errors can safely be avoided. The fittings 3 can be produced as cast parts, wherein the shoulders 13 or the groove 15 and the projection 17 can already be formed at the same time during casting. Alternatively, it is possible then to mill these parts into the aluminum block.

Two different fittings 3 are illustrated in FIG. 2. However, this is not absolutely necessary. It is also possible for the same fittings 3 to be used on both sides, either twice a fitting 3 with shoulder 13 or twice a fitting 3 with the groove 15 and the projection 17.

If a fitting 3 with a shoulder 13 is used so that the reinforcing element 7 is guided with a loop end 19c around the entire fitting, it is advantageous to form the rim of the fitting 3 so that there is no sharp edge which can damage the reinforcing element 7. For this purpose, the fitting 3 is equipped with a rounded portion 21 at its upper end, as is shown in FIG. 2. The shoulder or the groove can be undercut so that lateral sliding of the reinforcing element is prevented.

FIG. 3 shows a plan view of the surge arrester shown in FIG. 2, in which plan view the fitting 3 with the shoulders 13 can be seen. In this embodiment, two loop ends 19c, 19d are guided around the fitting 3 on opposite sides of the tensioning screw 4. In this way, a very symmetrical force can be exerted on the stack of the surge arrester. Since the reinforcing element 7 is formed from plastics in one piece, a certain flexibility is enabled in respect of the lengths of the individual sections 7a, 7b, 7c and 7d despite the dimensional stability of said reinforcing element, with the result that small manufacturing-induced fluctuations of the fittings 3 or of the reinforcing element 7 do not result in uneven force loading.

The embodiment shown in FIG. 2 is embodied in such a way that in each case two loop ends 19c, 19d and 19a, 19b rest on each fitting 3. This is also not necessary, and it is easily possible for three loop ends to be allowed to rest on each fitting 3, if desirable.

FIG. 4 shows a side view in detail of the second fitting 3 shown in FIG. 2. The configuration of the side face of the fitting with the groove 15 and the projection 17 is particularly advantageous when the reinforcing element 7 is formed from a very dimensionally stable plastics material, which can spread apart to only a small extent or with a relatively large force. The use of the fitting 3 at the end of the manufacturing process for the stack comprising the fitting 3, the varistor blocks 5 and the reinforcing element 7 can thus take place in such a way that the reinforcing element 7 snaps into the groove 15 and thus holds the stack. Furthermore, the guidance in the groove 15 has the advantage that the fitting 3 is fixed in its ultimate position and cannot slide further into the stack than is necessary. The tensioning of the tensioning screw 4 can then be performed easily and without the risk of damage to the varistor blocks 5.

Preferably, the fitting has a polygonal cross section, for example rectangular in the example shown in FIG. 2, wherein the sections of the reinforcing element 7 which connect the fittings 3 are provided at the corners. In this case, the cross section of this reinforcing element 7 is also rectangular or square. The outer housing can then be formed with a corresponding cross section, with the result that the use of the material for the outer housing can be optimized.

FIG. 5 shows a second embodiment according to the invention which differs from that shown in FIG. 2 in that two reinforcing elements 7, which each individually have an endless form, are provided. These two reinforcing elements 7 are guided on one fitting 3 so as to cross over one another and with a periphery formation around the fitting 3 with corresponding shoulders 13. In order to fix the reinforcing elements, it is possible to fit a holding apparatus 23 together with the central tensioning screw 4 in order to hold the reinforcing element 7 to be attached first before the second reinforcing element 7 is fitted.

In the example shown in FIG. 5, the second fitting 3 is again formed in such a way that grooves 15 and projections 17 are formed in its side face, with the respective loop ends of the reinforcing elements 7 being capable of snapping into said grooves and projections.

In this embodiment, too, provision is made, during installation, for first the end fitting 3 with the central tensioning screw 4 to be provided with the two reinforcing elements 7. Loop ends of the reinforcing elements 7 which are opposite the fitting 3 are spread so that the varistor blocks 5, the metal blocks 6 and the second end fitting 3 can be inserted. Then, the mechanical spreading of the reinforcing elements 7 is released, with the result that the respective loop ends latch into the grooves 15 around the Projections 17. Then, the required tension is exerted on the surge arrester with the central tensioning screw 4 or the previously described tensioning method.

Once the surge arrester core thus produced has been cleaned in a corresponding method step and, if required, impregnated, it is likewise encapsulated by injection moulding or encapsulated by casting with a silicone housing, wherein at the same time the shields are formed.

FIG. 6 shows a view of one fitting 3 with the tensioning screw 4 similar to that shown in FIG. 3. In this case, it can be seen that the two reinforcing elements 7, which wrap around the fitting 3, cross over one another on the outer side of the fitting 3 on which the tensioning screw 4 also acts.

FIG. 7 finally shows a side view in detail of the second fitting 3 in this embodiment. This view to this extent corresponds to the illustration in FIG. 4

In this second embodiment, two reinforcing elements 7 are provided. In this way, eight parallel sections of the reinforcing element 7 can extend from one fitting 3 to the other, and ensure the mechanical stability of the surge arrester to a large extent. The invention is not restricted to this concept. Each of the reinforcing elements 7 could rest with more than two loop ends on each fitting 3, for example it would be possible to provide in each case three loop ends on each fitting 3. The invention should also not be limited to providing two reinforcing elements 7. If a greater degree of stability is required, more than two reinforcing elements 7 can be fitted.

In the embodiment shown, the reinforcing element 7 has a rectangular cross section. This is preferable since the respective groove 15 or the shoulder 13 can thus be shaped correspondingly so that the reinforcing element 7 can rest nicely on the respective fitting 3. The invention is not restricted to this concept, however, and a round cross section for the reinforcing element 7 is likewise possible.

The groove or the shoulder is formed with an undercut in order to prevent lateral sliding of the reinforcing element 7. Further preferably, the groove is formed in such a way that the reinforcing element 7 is not held merely by resting in a form-fitting manner, but is additionally fixed by frictional engagement. This has the advantage that, in the event of breakage of a varistor block 5, the structural integrity of the surge arrester is maintained.

In the invention, the central tensioning screw 4 is provided in the end fitting 3, around which the loops of the reinforcing element 7 are guided. This is not essential either. The tensioning screw 4 can likewise be provided on the opposite fitting 3, it is also possible to provide tensioning screws on both fittings.

In the examples shown, the fittings 3 are each end fittings, which also ensure the electrical connection of the surge arrester to the line. However, it is also possible for an identical fitting 3 with an opposite alignment to be screw connected to one fitting 3 with the projection 17 and the groove 15, and thus to extend the surge arrester to double the length. The fitting 3 would then not be an end fitting but a central fitting. It is also possible to form corresponding grooves and projections with opposite alignment on the side face of the fitting 3, with the result that the fitting 3 can be inserted into a surge arrester as a coupling piece. In this way, surge arresters with relatively large physical lengths are possible, without the stability of the surge arrester being impaired.

Although the invention is shown using preferred examples, further amendments and modifications within the context of the attached claims are possible. It is possible, for example, to provide a rigid glass-fibre-reinforced plastics tube around the entire construction of the arrester instead of the silicone housing 9 with the shields 7 shown in FIG. 1, to terminate said plastics tube with corresponding end caps at the fittings 3 and to provide the module thus produced with a weather-resistant plastics housing with shields. Such surge arresters which combine the so-called “tubular design” with the “cage design” have particularly high mechanical stability and are therefore suitable for use even in regions at risk of earthquakes and under severe mechanical stress. It is also possible for the module according to the invention comprising fittings, varistor blocks and reinforcing elements to be accommodated in a porcelain housing, if desired.

Fittings 3

Tensioning screw 4

Varistor blocks 5

Metal block 6

Reinforcing element 7

Sections 7a, 7b, 7c, 7d

Housing 9

Shields 11

Shoulder 13

Groove 15

Projection 17

Lateral loop ends 19a, 19b, 19c, 19d

Rounded portion 21

Holding apparatus 23

1. Surge arrester comprising; two fittings (3); at least one varistor block (5), which is arranged between the fittings (3), and at least on reinforcing element (7) in the form of a closed loop, which holds the fittings (3) and the varistor block against one another under pressure; characterized in that the reinforcing element (7) is held on each of the two armatures (3) in each case on at least two sides of the fitting (3), and at least four sections (7a, 7b, 7c, 7d) of the reinforcing element (7) extend from one fitting (3) to the other fitting (3).

2. Surge arrester according to claim 1, characterized in that the reinforcing element (7) is formed from a rigid and dimensionally stable plastics material, preferably a glass-fibre-reinforced plastic material.

3. Surge arrester according to claim 1, characterized in that the reinforcing element (7) is guided at lest one fitting over a preformed shoulder (13).

4. Surge arrester according to either of claim 1, characterized in that the reinforcing element (7) is guided on at least one fitting (3) in a groove (15) formed in the side face of the fitting around a projection (17).

5. Surge arrester according to claim 1, characterized in that at least two reinforcing elements (7) are provided.

6. Surge arrester according to claim 1, characterized in that a screw (4) is provided in at least one of the fittings, which sire passes through a through-hole in the fitting (3) and acts as a tensioning screw.

7. Surge arrester according to claim 1, characterized in that the two fittings (3) are different from one another, wherein one fitting is formed with shoulders (13) around which loop ends (19c, 19d) of the reinforcing element (7) are guided, wherein the other fitting is equipped with grooves (51) and projections (17) in/on its side face around which lateral loop ends (19a, 19b) of the reinforcing element (7) are guided.

8. Surge arrester according claim 1, characterized in that the surge arrester is provided with a silicone housing (9), preferably with shields (11).

9. Surge arrester according to claim 2, characterized in that the reinforcing element (7) is guided en at least one fitting over a preformed shoulder (13).

10. Surge arrester according to either of claim 2, characterized in that the reinforcing element (7) is guided on at least one fitting (3) in a groove (15) formed in the side face of the fitting around a projection (17).

11. Surge arrester according to claim 2, characterized in that at least two reinforcing elements (7) are provided.

12. Surge arrester according to claim 3, characterized in that at least two reinforcing elements (7) are provided.

13. Surge arrester according to claim 4, characterized in that at least two reinforcing elements (7) are provided.

14. Surge arrester according to claim 2, characterized in that a screw (4) is provided in at least one of the fittings, which screw passes through a through-hole in the fitting (3) and acts as a tensioning screw.

15. Surge arrester according to claim 3, characterized in that a screw (4) is provided in at least one of the fittings, which screw passes through a through-hole in the fitting (3) and acts as a tensioning screw.

16. Surge arrester according to claim 4, characterized in that a screw (4) is provided in at least one of the fittings, which screw passes through a through-hole in the fitting (3) and acts as a tensioning screw.

17. Surge arrester according to claim 5, characterized in that a screw (4) is provided in at least one of the fittings, which screw passes through a through-hole in the fining (3) and acts as a tensioning screw.

18. Surge arrester according to claim 2, characterized in that the two fittings (3) are different from one another, wherein one fitting is formed with shoulders (13) around which loop ends (19c, 19d) of the reinforcing element (7) are guided, wherein the other fitting is equipped with grooves (15) and projections (17) in/on its side face around which lateral loop ends (19a, 19b) of the reinforcing element (7) are guided.

19. Surge arrester according to claim 6, characterized in that the two fittings (3) are different from one another, wherein one fitting is formed with shoulders (13) around which loop ends (19c, 19d) of the reinforcing element (7) are guided, wherein the other fitting is equipped with grooves (15) and projections (17) in/on its side face around which lateral loop ends (19a, 19b) of the reinforcing element (7) are guided.

20. Surge arrester according to claim 7, characterized in that the surge arrester is provided with a silicone housing (9), preferably with shields (11).
